(19) United States
(12) Patent Application Publication
(10) Pub. No.: US 2007/0289761 A1
(43) Pub. Date: Dec. 20, 2007

(54) Auxiliary Handle for a Hand-Held Power Tool

(75) Inventors: Rainer Kumpf, Ilsfeld (DE); Thomas Robieu, Schwaikheim (DE)

Correspondence Address: GUDRUN E. HUCKETT DRAUDT, SCHUBERTSTR. 15A, WUPPERTAL, 42289, omitted

(73) Assignee: A & M Electric Tools GmbH, Winnenden (DE)

(21) Appl. No.: 11/762,245

(22) Filed: Jun. 13, 2007

(30) Foreign Application Priority Data
Jun. 14, 2006 (EP) 06 012 213.2
May 19, 2007 (EP) 07 010 000.3

(51) Int. Cl. B25D 17/24; B25D 17/00

(52) U.S. Cl. 173/162.1; 173/162.2

(57) ABSTRACT

An auxiliary handle for a hand-held power tool has a handle part gripped by a hand of an operator and defining an axial direction. An attachment part with which the auxiliary handle is to be attached to a power tool is provided. An elastic damping element connects the handle part and the attachment part, wherein the handle part is secured to the attachment part by positive fit. A unitary holding section is connected to the handle part or the attachment part and a unitary securing section is connected to the attachment part or the handle part. The holding section surrounds with lateral play in all directions the securing section on all sides so that a damping space is generated between the securing section and the holding section. The damping element fills out the damping space at least partially.

### BACKGROUND OF THE INVENTION

The invention relates to an auxiliary handle of a hand-held power tool, in particular, an angle grinder or cut-off machine, a buffing machine, a power drill, or the like. The auxiliary handle comprises a handle part to be gripped by the hand of the operator and an attachment part connected to the power tool, wherein the handle part is attached by means of an elastic damping element to the attachment part and is positive-lockingly secured to the attachment part.

Hand-held power tools such as angle grinders or cut-off machines, buffing machines, power drills or the like have a main handle that is unitarily formed on or attached to the motor housing or the like. The power tool is gripped by the handle and guided by means of the handle. In addition to this handle, it may be expedient to provide an auxiliary handle for the second hand of the user. Such an auxiliary handle is detachably attached, for example, to the gear housing of the power tool. When embodied as a stick handle, it projects radially relative to the longitudinal axis of the power tool and facilitates guiding in the case of difficult machining steps.

The operation of the power tool results in vibrations that travel from the power tool, in particular through the auxiliary handle, into the hand or arm of the operator. For reducing the vibration level acting on the operator, prior art stick handles or auxiliary handles are provided with elastic damping elements. In this connection, a handle part is connected by means of the elastic damping element to an attachment part of the power tool. In order to avoid excessive elastic deformations in the case of corresponding high manual forces, stops or the like can be provided. Moreover, a securing action is required that prevents, when the elastic damping element is damaged, complete detachment of the handle part from the attachment part.

Such an auxiliary handle is disclosed in German patent application 100 29 536 A1. In the different embodiments disclosed therein an at least partially exposed disk-shaped damping element is provided as a connector between a handle part and an attachment part. A wire cable, a screw having play or the like serves as a securing element that, on the one hand, enables a limited elastic deformation and, on the other hand, prevents the handle part from being ripped off when the damping element becomes damaged. The arrangement of the additional securing element causes additional costs and additional weight. The elastic damping element is unprotected and exposed to external influences.

German patent application 39 13 971 A1 discloses a vibration-isolated handle construction in which a main handle having a holding section is formed by two half shells that are screwed together. The two half shells of the holding section surround a securing section of the power tool with play. In the intermediate space between the holding section and the securing section a total of eight damping elements are arranged which are designed to provide vibration insulation. The construction is complex and cost-intensive with regard to manufacture and assembly. The arrangement of the large number of individual damping elements for supporting the main handle in all spatial degrees of freedom of movement require a large mounting space which, in the case of an auxiliary handle, limits the movability of the power tool. An adaptation to different stiffness and damping properties for different degrees of freedom of movement is difficult. Depending on the load direction, only a part of the damping elements will be loaded. The additional damping elements do not contribute to the damping action.

### SUMMARY OF THE INVENTION

It is an object of the present invention to further develop the auxiliary handle of the aforementioned kind in such a way that a safe and simple vibration-damped connection between the handle part and the attachment part is provided.

This object is solved by an auxiliary handle provided with a unitary holding section that surrounds with positive fit (positive lock) a unitary securing section on all sides so as to form a damping space, wherein the damping element fills out the damping space at least partially.

An auxiliary handle of a hand-held power tool is proposed in which the holding section and the securing section each are formed as a unitary part wherein the holding section surrounds with positive fit the securing section on all sides with play so as to form a damping space. The damping element fills out the damping space at least partially, preferably completely. The selected wording “surrounding on all sides” means that enclosure in all spatial direction is provided wherein a hermetic enclosure is possible but not necessary. The enclosure from all sides, on the one hand, provides a positive locking positional securing of the handle part relative to the attachment part. On the other hand, the damping element is secured captively and protected from external influences. The handle part cannot become detached from the attachment part even when the damping element is damaged. The unitary configuration of the holding section and of the securing section, respectively, improves the load capacity while reducing manufacturing and assembly costs. Since the damping element fills out the damping space, it is loaded as a whole when a relative damping movement occurs wherein the existing damping material in its totality is utilized for the damping action. In comparison to the prior art, a significantly more compact configuration is obtained while a high load capacity is provided; as a result of the reduced constructive space and the reduced weight, this contributes to improved handling of the power tool.

It can be expedient to produce the holding section, the securing section, and the damping element as individual parts wherein the damping element, for example, is fitted into the damping space or connected by an adhesive. In a preferred embodiment, the damping element, the holding section, and the securing section are formed as multi-component injection molded parts. With minimal manufacturing and assembly expenditure, an intimate connection between the three components is produced. The individual materials adhere to one another so that at the contact surfaces in addition to compressive stress also tensile stress and shearing stress can be transmitted. In this way, it is ensured that the existing damping material as a whole contributes to the damping action.

In a preferred embodiment, the securing section engages captively the holding section when the damping element is missing. Inasmuch as the damping element is damaged or even destroyed, the handle, even when the damping element is missing completely, cannot become detached from the power tool; this improves the operational safety of the power tool.

In an expedient embodiment, the safety section has at least two, and preferably three, securing projections that are spaced in the circumferential direction at a spacing from one another and project radially outwardly. The holding section has a circumferential wall that delimits the damping space in the radial direction wherein the circumferential wall has securing openings correlated with the securing projections. The securing projections engage the securing openings so that a spacing relative to the edges of the safety openings is provided on all sides. Expediently, the spacing between the securing projections and the edges of the securing openings is filled with the material of the damping element. A defined independently adjustable damping action can be obtained in all spatial degrees of freedom of the lateral and pivoting relative movement between handle part and power tool. The circumferential wall as well as the front wall and the back wall of the holding section delimit the lateral and also the pivoting degrees of freedom of movement. The interaction of the securing projections with the edges of the securing openings and the intermediately positioned material of the damping elements contribute moreover to the adjustment of the stiffness and damping behavior at relative pivoting and torsional movement. The damping material that is intermediately positioned in any direction provides that individual components, for example, the securing projections, impact on the holding section. The securing openings allow also a visual control of the damping elements so that damage, wear, and the like can be recognized in time.

In a preferred embodiment, the holding section and the securing section are produced as two separate individual parts, non-detachable from one another, in a common injection molding process. In only one cost-saving injection molding process two individual parts are produced that engage one another non-detachably so that, without additional assembly expenditure, the desired mutual captive positional securing action is achieved.

In an advantageous alternative, the securing projections of the securing section engage like a bayonet closure the holding section with the holding projections. When mounting, the securing section is inserted axially into the holding section. After a subsequent mutual rotation of both components in the way a bayonet closure is operated a positive-locking positional securing action is provided without this requiring further assembly work in particular with regard to combining several individual parts. Only the damping element/s is/are to be inserted and in particular embedded by injection molding so that the bayonet connection is fixed in place and the elastic damping connection is produced.

In an advantageous embodiment the securing projections are positioned in the circumferential direction at the same spacing relative to one another, respectively. This provides an isotropic, i.e., a directionally independent stiffness and damping behavior. In the case of the usually employed screw connection for connecting the auxiliary handle and the power tool, the angular position of the auxiliary handle is not important when screwing on the handle. No additional measures for adjustment of a certain angular position are required.

It can be expedient to arrange the holding section on the attachment part and the securing section on the handle part. The reverse configuration according to which the holding section is arranged on the handle part and the securing section on the attachment part is preferred.

In an expedient embodiment a constructive unit of the holding section and of a grip pipe of the handle part is of a unitary configuration. In this case, a highly loadable and still lightweight configuration is possible at further reduced manufacturing and assembly expenditure. Advantageously, the material of the elastic damping element is arranged at least partially, in particular unitarily, about the grip pipe and preferably at least partially about the holding section on the external side. Without additional manufacturing and assembly expenditure the surface feel (“grip”) of the auxiliary handle is improved. At the same time, the externally positioned material of the damping element also provides an impact and shock absorbing action with respect to external loads.

### BRIEF DESCRIPTION OF THE DRAWING

FIG. 1 is a perspective illustration of a first embodiment of the auxiliary handle according to the invention as a multi-component injection molded part with unitary holding section and unitary securing section.

FIG. 2 is an exploded view of the auxiliary handle according to FIG. 1 without damping element for illustrating constructive details.

FIG. 3 shows a longitudinal section of the auxiliary handle according to FIGS. 1 and 2 with details of the interaction of the individual parts.

FIG. 4 is a plan view onto the holding section of the preceding Figures with details in regard to removal from the mold in the case of manufacture as a multi-component injection molded part.

FIG. 5 is a cross-sectional illustration of the securing section according to the preceding Figures shown together with the holding section according to FIG. 4 showing details of the removal from the mold in the case of manufacture as a multi-component injection molded part.

FIG. 6 is a cross-sectional illustration of the completed injection molded auxiliary handle in the area of the holding and securing sections with details in regard to the dampened support of the intermediately positioned damping element.

FIG. 7 is a longitudinal section of a further embodiment of the auxiliary handle according to the invention with details in regard to a positive-locking bayonet closure of the securing section and the holding section with intermediate positioning of the elastic damping element.

FIG. 8 is a perspective illustration of the auxiliary handle according to FIG. 7 with details of the bayonet closure between the securing section and the holding section as well as the damping space completely filled by injection with the material of the elastic damping element.

### DESCRIPTION OF THE PREFERRED EMBODIMENTS

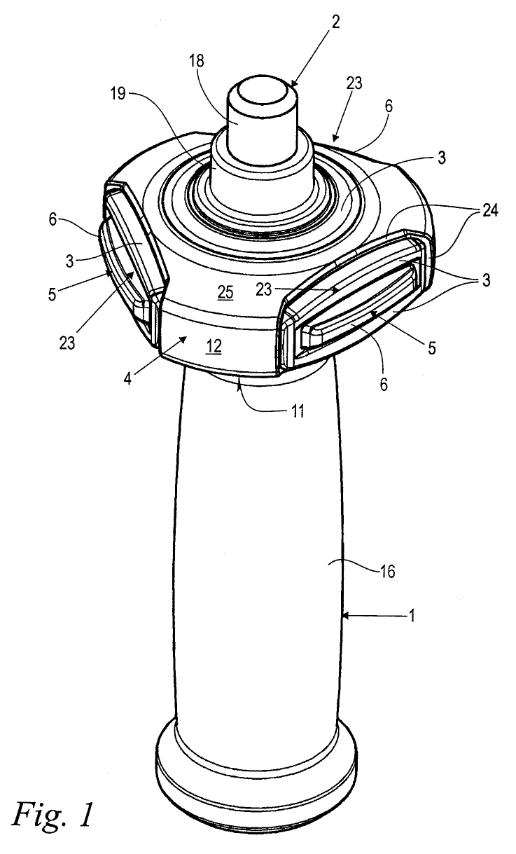

FIG. 1 shows in a perspective illustration an auxiliary handle according to the invention that is designed for use with a hand-held power tool, in particular, an angle grinder or cut-off machine, a buffing machine, a power drill or the like. The illustrated auxiliary handle comprises a handle part 1 that in operation is gripped by the hand of the operator. Further parts of the auxiliary handle are an attachment part 2 and an elastic damping element 3 with which the handle part 1 is attached in a vibration-damping way to the attachment part 2.

A screw 18 with thread projects from the attachment part 2 coaxially to the auxiliary handle 1 and is provided for screw-connecting the auxiliary handle to the power tool. In the usual operating position, the longitudinal axis of the auxiliary handle is radial to the longitudinal axis of the power tool and, depending on the application, can be oriented laterally, toward the top, downwardly, as well as in any intermediate position. The screw attachment of the auxiliary handle on the power tool is realized usually near the driven tool part, in particular, in the area of a gear housing.

The screw 18 penetrates centrally and coaxially a hub 19 of the attachment part 2. The securing section 5 and the hub 19 are formed as a unitary part. The securing section 5 is embodied as a plane, radially and circumferentially extending section. The hub 19 and the securing section 5 form together the attachment part 2.

The handle part 1 comprises an approximately cylindrically embodied grip pipe 16 that passes into a cylindrical holding section 4 in the area of the attachment part 2; the holding section 4 projects in the radial direction past the grip pipe 16. The attachment of the handle part 1 by means of the damping element 3 on the attachment part 2 is realized in the area of the holding section 4 and of the securing section 5. The opposed free end of the grip pipe 16 in the axial direction is unprotected so that the attachment of the auxiliary handle at the power tool is realized simply by means of the screw 18. The illustrated construction is referred to also as a stick handle.

The holding section 4 is approximately drum-shaped and comprises an at least approximately cylindrical circumferential wall 12 that is adjoined in the direction toward the grip pipe 16 by a back wall 11 and in the direction toward the screw 18 or the power tool, not illustrated, by a front wall 25. The back wall 11 and the front wall 25 are approximately circular disk-shaped and have a slightly conical shape. The holding section 4 with the circumferential wall 12, the back wall 11, and the front wall 25 is manufactured as unitary part of plastic material by injection molding. Preferably, at least two, in the illustrated embodiment at least three, securing openings 23 are formed in the circumferential wall; they extend partially into the back wall 11 and the front wall 25. The securing section 5 has at least two, in the illustrated embodiment three, securing projections 6 that are positioned at a spacing to one another in the circumferential direction and project radially outwardly; they are correlated with the securing openings 23 and engage the securing openings 23 in such a way that a spacing to the edges 24 of the securing openings 23 is provided at all sides. The securing section 5 and the three securing projections 6 are manufactured together as a unitary plastic part by injection molding.

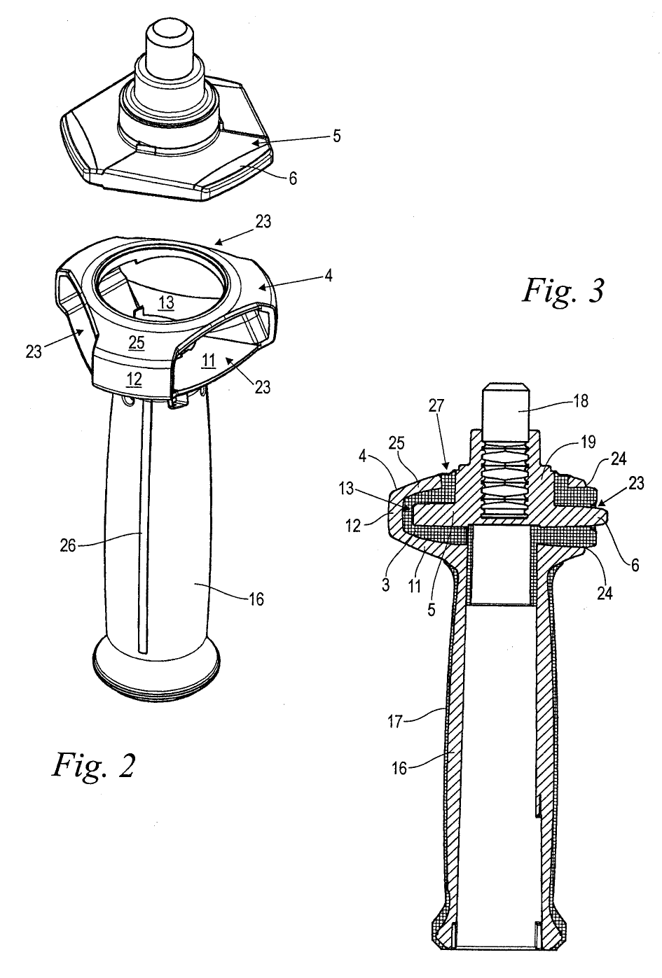

The unitary holding section 4 surrounds on all sides with play the unitary securing section 5 so that a damping space 13 to be described in connection with FIGS. 2 and 3 is formed. The damping element 3 that is also formed as a unitary part fills out the damping space 13 (FIGS. 2 and 3) completely. The holding section 4 that forms together with the grip pipe 16 a unitary part, the securing section 5, and the damping element 3 are manufactured in one processing step as a multi-component injection molded part in a way to be described infra.

FIG. 2 shows an exploded view of the auxiliary handle according to FIG. 1 without the damping element 3 illustrated in FIG. 1. It can be seen that the circumferential wall 12, the back wall 11, and the front wall 25 of the holding section 4 delimit the damping space 13. The securing projections 6 of the securing section 5, illustrated as a separate individual part, have a circular section-shaped outer edge whose radius matches approximately the radius of the circumferential wall of the holding section 4. In contrast to the exploded illustration according to FIG. 2, the securing projections 6 penetrate the correlated securing openings 23 (FIG. 3) in the operating position. This in combination with the closed construction of the back wall 11 and the front wall 25 in the circumferential direction provides for the securing section 5 in the operating position according to FIG. 3 being captively secured within the holding section 4 even for a damaged or even missing damping element 3 and despite the presence of the securing openings 23. Moreover, it can be seen that the securing projections 6 and also the securing openings 23 are arranged at the same spacing relative to one another in the circumferential direction and are uniformly distributed.

FIG. 3 shows a longitudinal section illustration of the auxiliary handle according to FIG. 1 and FIG. 2 with details of the interaction of individual parts. It can be seen that the damping space 13 is filled out completely, without any gap and cavities, by the damping element 3. Between a radially inwardly positioned circumferential edge of the front wall 25 in the hub 19 of the securing section 5, a circumferential gap 27 is formed that is filled out by the material of the damping element 3. Moreover, it can be seen that the securing section 5 has a spacing or play relative to the holding section 4 in all spatial directions, i.e., relative to the circumferential wall 12, to the back wall 11 and to the front wall 25. This spacing that forms the damping space 13 defines the contour of the damping element 3.

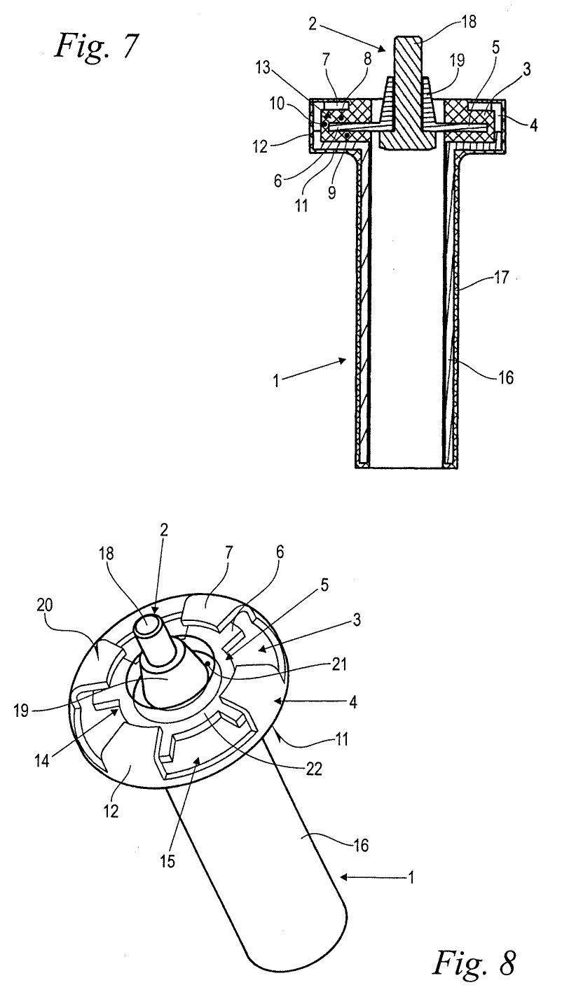

Moreover, the longitudinal section illustration according to FIG. 3 shows that the securing projection 6 projecting through the securing opening 23 has an uninterrupted spacing relative to the circumferentially extending edges 24 of the securing openings 23, respectively, wherein this spacing is filled with the material of the damping element 3. The material of the elastic damping element 3 extends unitarily at least partially about the grip pipe 16 on the exterior and thus forms a soft envelope 17. Only one or several ribs 26, illustrated in FIG. 2, of the harder and stiffer material of the grip pipe 16 project past the envelope 17 and improve the surface feel (grip) of the grip pipe 16. Moreover, it can be expedient that the material of the elastic damping element 3, in analogy to the illustration of FIG. 7, extends at least partially about the holding section 4 on the exterior.

The screw 18, in accordance with the illustration of FIG. 3, is provided with an external structure that is embedded by injection molding in the material of the hub 19. In this way, the screw 18 is captively secured in the hub 19. However, a different type of connection of the screw 18 and the hub 19, for example, in accordance with FIG. 7, can also be expedient.

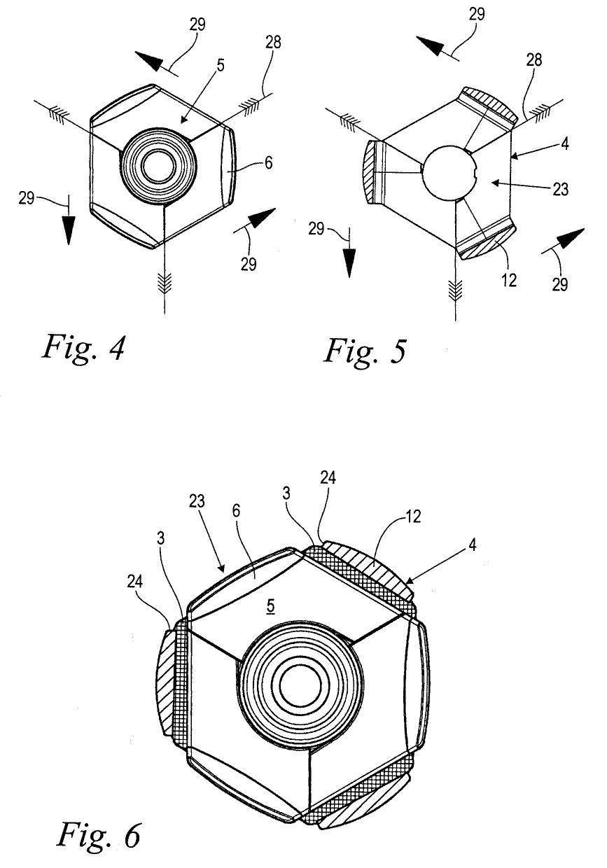

FIGS. 4 and 5 show a plan view onto the holding section or a cross-sectional illustration of the securing section according to FIGS. 1 to 3 with details in regard to the common removal from the mold when manufacturing a multi-component injection molded part. In deviation from the exploded illustration of FIG. 2, the holding section 4 and the securing section 6 are injection-molded together in the position in accordance with illustration of FIG. 3. For this purpose, at the location of the future securing openings 23 mold slides are inserted that contact one another at separating lines 28. The mold slides delimit together the mold cavities for the holding section 4 as well as for the securing section 5. After completion of the injection molding process, they are pulled out in accordance with the arrows 29 parallel to the inner surfaces of the circumferential walls 12. Holding section 4 and securing section 5 remain as two separate parts that, however, mesh with or engage one another and are captively (non-detachably) secured relative to one another in accordance with the illustration of FIG. 2 and FIG. 3.

In supplementing the illustration according to FIG. 3, the cross-sectional illustration according to FIG. 6 also shows that securing projections 6 that engage the securing openings 23 not only have a spacing to the upper and lower circumferentially extending edges 24 but also have a spacing to the edges 24 of the securing openings 23 that extend axis-parallel and adjoin in the circumferential direction the securing projections 6; the resulting space is filled out by the material of the damping element 3. In this way, and by the position of the damping element 3 in the radial direction between the securing section 5 and the circumferential wall 12 of the holding section 4, a dampened rotational securing action of both parts relative to one another is provided.

FIG. 7 shows a cross-sectional illustration of a further auxiliary handle according to the invention. Inasmuch as not noted otherwise, the embodiments according to FIGS. 1 to 6 as well as to FIGS. 7 and 8 are identical with regard to their features and reference numerals.

The holding section 4 and the grip pipe 16 form a monolithic part wherein the holding section 4 is injection-molded from plastic material onto the grip pipe 16 and has the contour of a cylindrical drum. The holding section 4 comprises at the axial end opposite the screw 18 a circular disk-shaped back wall 11 and an adjoining cylindrical circumferential wall 12. On the end face that is facing the screw 18 in the axial direction, a number of holding projections 7 project, beginning at the circumferential wall 12, radially inwardly. In the radial direction they project farther inwardly than the outer diameter of the securing projections 6 of the securing section 5.

The securing section 5 engages with its radial outwardly projecting securing projections 6 with play on all sides the holding section 4 to thus form a damping space 13. The damping space 13 is thus delimited in the radial direction by the circumferential wall 12, in the axial direction pointing away from the screw 18 by the back wall 11, and in the opposite direction, i.e., in the direction pointing toward the screw 18, delimited by the holding projections 7. The securing projections 6 overlap in the axial direction the holding projections 7, on the one hand, and the back wall 11, on the other hand. The handle part 1 is thus positive-lockingly secured in the axial and radial directions as well as in the tilting direction on the securing projections 6 of the attachment part 2.

The damping space 13 is filled out monolithically and completely with the material of the elastic damping element 3. This enables an elastic and vibration-damped relative movement of the handle part 1 relative to the attachment part 2 wherein this relative movement however is limited by the elastic deformability of the damping element 3 in connection with the interaction between the holding section 4 and the securing section 5. When the damping element 3 is damaged, the positive-lockingly engagement of the securing section 5 in the holding section 4 prevents complete detachment of the handle part 1 from the attachment part 2.

As a material for the damping element 3 an injection-molded PU (polyurethane) polymer or TPE polymer (TPE=thermoplastic elastomer) is selected, for example. In the illustrated embodiment, this material is wrapped by way of injection molding as a monolithic part completely about the holding section 4 and also the grip pipe 16. For the grip pipe 16 and the holding section 4 a stiffer impact-resistant plastic material is selected. The constructive unit of holding section 4 and grip pipe 16 is injection-molded as a unitary part from this plastic material.

FIG. 8 shows a perspective view of the auxiliary handle according to FIG. 7 in the mounted state wherein the damping element 3, for illustrating the interaction between the holding section 4 and the securing section 5, is illustrated to be transparent. In comparison to the illustration of FIG. 7, same features are identified with same reference numerals.

The perspective view according to FIG. 8 shows that the cylindrical circumferential wall 12 as well as an end face 20 of the holding section 4 facing the screw in the axial direction is interrupted by a total of four same size intermediate spaces 15. Accordingly, by means of the remaining parts of the circumferential wall 12 and the end face 20 a number of a total of four holding projections 7 are formed that are positioned at the same spacing to one another in the circumferential direction. The circumferential extension of the holding projections 7 and of the intermediately positioned spaces 15 is identical for all four holding projections 7. The holding projections 7 begin at the back wall 11 and extend in the axial direction toward the screw 18. In their further course they are radially inwardly angled, i.e., they project radially inwardly from the circumferential wall 12 in the direction toward the central axis of the auxiliary handle.

From the hub 19, a plane circular disk 22 projects radially outwardly and has an outer diameter that is smaller than the diameter formed by the radial inner end end of the holding projections 7. A total of four plane securing projections 6 extends, beginning at the circular disk 22, radially outwardly; their outer diameter is greater than the diameter formed by the radial inner ends of the holding projections 7. In an axial plan view, the contour of the securing projections 6 in the overlap area is identical to the contour of the holding projections 7. Instead of the illustrated four securing projections 6 and holding projections 7, a different number can also be expedient wherein preferably at least two and, in particular, at least three securing projections 6 and holding projections 7 are provided. In each case, the same number of securing projections 6 and holding projections 7 is to be selected.

For mounting, the attachment part 2 is rotated about its longitudinal axis such that the securing projections 6 in the axial direction are aligned with the intermediate spaces 15 of the holding projections 7. In the circumferential direction between the securing projections 4 positioned at the same space relative to one another there are also intermediate spaces 14 positioned at the same spacing relative to one another which, in the rotated mounting position, are aligned in the axial direction with the holding projections 7. In this rotated position, the securing section 5 with its securing projections 6 can be inserted axially into the holding section 4 to such an extent that the securing projections 6 in the axial direction are positioned between the holding projections 7 and the back wall 11. Subsequently, in accordance with the well-known actuation of a bayonet closure, a relative rotation of the attachment part 2 and of the handle part 1 about the common longitudinal axis takes place. In respect to the exemplary illustrated number of a total of four securing projections 6 and holding projections 7, this relative rotation is 45 degrees so that each securing projection 6 engages behind a holding projection 7, respectively, in accordance with the illustration of FIG. 6. For a deviating number of securing projections 6 and holding projections 7, an appropriately selected deviating angular rotation is required for generating the positive-locking bayonet connection.

In the bayonet-type locked position according to FIG. 8, the constructive unit of the handle part 1 and the attachment part 2 is inserted into a mold for injection molding wherein the attachment part 2 is secured relative to the handle part 1 such that the damping space 13 resulting from the play or spacing between the parts provided at any side is formed according to FIG. 7. In this secured position, the damping space 13 and also the external surface of the holding section 4 and of the grip pipe 16 are filled out by injection molding with the material of the damping element 3. In the area of the hub 19 a cylindrical recess 21 is provided in the damping element 3 for producing a screw connection by means of screw 18 (FIG. 8).

The illustration according to FIG. 7 shows that in the axial direction between the securing projections 6 and the holding projections 7 a first pressure-loadable damping section 8 of the damping element is formed. In the opposite axial direction between the securing projections 6 and the back wall 11 the second damping section 9 of the damping element 3 is formed. In the radial direction between the securing projections 6 and the circumferential wall 12 of the holding section 4, third damping sections 10 of the damping element 3 are arranged, respectively. The damping sections 8, 9, 10 of the damping element 3 are formed as unitary parts. It can also be expedient to make individual damping sections 8, 9, 10 and to insert them separately.

For a deformation of the handle part 1 relative to the attachment part 2 in radial, axial or tilting direction, at least one of the damping sections 8, 9, 10 is pressure-loadable wherein the elastic yielding action is limited. On the one hand, it is determined by the non-linear pressure spring behavior of the elastomer material of the damping element 3. On the other hand, the deformation travel is limited by the complete engagement of the securing section 5 and the damping element 3 by means of the holding section 4 in the axial direction and radial direction.

The illustration according to FIG. 8 also shows that the intermediate spaces 14, 15 between the securing projections 6 and holding projections 7 are also filled in the circumferential direction by material of the elastic damping element 3. In the circumferential direction, this results in a positive-locking attachment and positional securing action of the handle part 1 relative to the attachment part 2.

An embodiment can also be expedient that, while maintaining the other features, has a reverse configuration in that the securing section 5 is arranged on the handle part 1. The holding section 4 is correlated with the attachment part 2 and surrounds the damping element 3 as well as the securing section 5 of the handle part 1.

The specification incorporates by reference the entire disclosure of European priority documents 06012213.2 having a filing date of Jun. 14, 2006, and 07010000.3 having a filing date of May 19, 2007.

While specific embodiments of the invention have been shown and described in detail to illustrate the inventive principles, it will be understood that the invention may be embodied otherwise without departing from such principles.

What is claimed is:

1. An auxiliary handle for a hand-held power tool, the auxiliary handle comprising:
a handle part gripped by a hand of an operator and defining an axial direction;
an attachment part with which the auxiliary handle is to be attached to a power tool;
an elastic damping element connecting the handle part and the attachment part, wherein the handle part is secured to the attachment part by positive fit;
a unitary holding section connected to the handle part or the attachment part;
a unitary securing section connected to the attachment part or the handle part;
wherein the holding section surrounds with lateral play in all directions the securing section on all sides so that a damping space is generated between the securing section and the holding section;
wherein the damping element fills out the damping space at least partially.

2. The auxiliary handle according to claim 1, wherein the damping element, the holding section, and the securing section form a multi-component injection molded part.

3. The auxiliary handle according to claim 1, wherein the securing section engages captively the holding section when the damping element is missing.

4. The auxiliary handle according to claim 3, wherein the securing section has at least two securing projections that are spaced from one another in a circumferential direction of the securing section and that project radially outwardly, wherein the holding section has a circumferential wall that delimits the damping space in a radial direction, wherein the circumferential wall has at least two securing openings having edges, and wherein the at least two securing projections engage the at least two securing openings in such a way that a spacing is provided between the at least two securing projections and all of the edges of the at least two securing openings.

5. The auxiliary handle according to claim 4, wherein the spacing between the at least two securing projections and the edges is filled out by material of the damping element.

6. The auxiliary handle according to claim 4, wherein the at least two securing projections have identical spacing relative to one another in the circumferential direction.

7. The auxiliary handle according to claim 1, wherein the holding section and the securing section are two separate, but captively secured individual parts made by a common injection molding process.

8. The auxiliary handle according to claim 1, wherein the securing section has securing projections and the holding section has holding projections, wherein the securing projections and the holding projections engage one another to form a bayonet closure.

9. The auxiliary handle according to claim 1, wherein the holding section is arranged on the handle part and wherein the securing section is arranged on the attachment part.

10. The auxiliary handle according to claim 9, wherein the holding section and a grip pipe of the handle part are formed as a unitary part.

11. The auxiliary handle according to claim 1, wherein the handle part has a grip pipe and the grip pipe is at least partially surrounded by an envelope, wherein the envelope consists of the material of the elastic damping element.

12. The auxiliary handle according to claim 11, wherein the envelope and the damping element form a unitary part.

13. The auxiliary handle according to claim 11, wherein the envelope extends at least partially also about the holding section.

14. The auxiliary handle according to claim 13, wherein the envelope and the damping element form a unitary part.
